(19) United States
(12) Patent Application Publication
(10) Pub. No.: US 2025/0375351 A1
(43) Pub. Date: Dec. 11, 2025

(54) FOOT MASSAGER WITH PRESSURE POINT CONTROLLER AND ADJUSTABLE CONTROL STIMULATORS

(71) Applicant: Paul Shridath Ramphal, Nassau (BS)

(72) Inventor: Paul Shridath Ramphal, Nassau (BS)

(21) Appl. No.: 18/735,586

(22) Filed: Jun. 6, 2024

Related U.S. Application Data
(60) Provisional application No. 63/494,475, filed on Apr. 6, 2023.

(51) Int. Cl. A61H 39/04

(52) U.S. Cl. CPC A61H 39/04; A61H 2201/5043; A61H 2205/125

(57) ABSTRACT

A Robotic Self-Massager delivers pre-programmed, or user-defined, massages according to user selections. The Robotic Self-Massager includes actuators connected to one or more massage pads and a controller that controls the actuators to deliver massages selected by the user. The Robotic Self-Massager can include a user interface to provide options, or customizations, to the user for selection.

### CROSS-REFERENCE TO RELATED APPLICATION

This application claims the benefit of priority of U.S. provisional application No. 63/494,475, filed Apr. 6, 2023, the contents of which are herein incorporated by reference.

### BACKGROUND OF THE INVENTION

The present invention relates to body massagers and, more particularly, to a foot massager and system thereof.

Pressure points develop in various locations of the body, such as the back and feet, and can be due to stress and anxiety as a result of physical and mental exertion. Pressure points can be quite painful and left untreated can cause undesired health effects, such as high blood pressure and muscle dysfunction.

Chronic foot pain, e.g., can have a significant impact on an individual's quality of life in the form of increased health care expenses and reduction in mobility. People suffering from chronic foot pain may be forced to limit or eliminate their work and recreational activities based on their ability to walk and manage pain.

Massaging a body part, such as the feet and back, can be performed by massage therapists or one or many commercially available mechanical massagers. However, massage therapists and mechanical massagers lack necessary knowledge and skill needed to implement and execute a precision-based treatment session designed for optimal therapeutic relief. Due to these limitations, an improperly performed massage can result in injury or even damage to nerves, cause muscle spasms, and cause inflammation.

As can be seen, there is a need for a massager having the functionality and precision necessary to implement and execute a precision-based treatment session designed for optimal therapeutic relief.

### SUMMARY OF THE INVENTION

In one aspect of the present invention a Robotic Self-Massaging system is provided. The system includes one or more massage pads, a plurality of actuators, which can be pneumatic actuators, coupled to the one or more massage pads, with each actuator configurable to have one or more positions and one or more modes of operation. The system includes a controller communicably coupled with the plurality of actuators, configured to position the actuators to contact selected anatomical pressure points. The controller is further configured to actuate the plurality of actuators in accordance with one or more massage modalities and the one or more modes of operation. Each of the one or more massage modalities comprises a massage routine and at least one element of information selected from the group consisting of: actuator position information, actuator orientation information, actuator velocity information, actuator acceleration information, and massage duration information.

The controller of the system can include an interactive graphical display unit configured to display pressure points, and send one or more user defined messages, commands, or both to the controller. The controller, in response to receiving the one or more messages, commands, or both, can perform one or more processing actions according to the one or more messages, commands, or both.

### BRIEF DESCRIPTION OF THE DRAWINGS

FIG. 1 is a schematic view of a robotic foot self-massager according to an embodiment of the present invention;

FIG. 2A is a schematic view of a robotic foot self massager footpad and sP array according to an embodiment of the present invention, shown in a default configuration;

FIG. 2B is a schematic view thereof, shown in a condensed configuration;

FIG. 3B is a schematic view thereof, shown in an elongated configuration;

FIG. 3A is a schematic view of a robotic foot self-massager footpad and sP array according to another embodiment of the present invention, shown in a default configuration;

FIG. 3B is a schematic view thereof, shown in a condensed configuration;

FIG. 3C is a schematic view thereof, shown in an elongated configuration;

FIG. 4 is a schematic view of a robotic foot self-massager footpad according to another embodiment of the present invention;

FIG. 5 is a schematic view of a robotic foot self-massager according to another embodiment of the present invention;

FIG. 6 is a schematic view of a robotic foot self-massager according to yet another embodiment of the present invention;

FIG. 7 is a schematic view thereof, having actuator buttons according to another embodiment of the present invention;

FIG. 8 is a schematic view of a robotic foot self-massager according to a further embodiment of the present invention;

FIG. 9 is another schematic view thereof, illustrating alternate controller and central processing unit (CPU) configurations;

FIG. 10A is a schematic view of a robotic foot self-massager according to another embodiment of the present invention;

FIG. 10B is a detail view thereof; and

FIG. 11 is an illustrative example of a general and/or special purpose computer according to an embodiment of the present invention, for use with the robotic foot self-massager disclosed herein.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Considering the previous discussion concerning limitations of prior art methods of rendering a foot massage, a mechanical massager should have precision-controlled stimulators and allow a user to design and save a massage sequence/session that can be initiated at any time thereafter and form part of a library of massage protocols in the device. Further, use of the massager should not require the user to adopt unusual, unnatural, or uncomfortable postures to facilitate massage of the sole of the foot. It should be possible to massage one foot at a time or both feet simultaneously as the user desires. Lastly, it should be possible for the user to employ other modalities, such as heat, vibration, or electro-stimulation, simultaneous with pressure point massage or at a different point in time.

Numerous publications in the international medical and allied medical literature have demonstrated that massage therapy, and specifically foot massage therapy using acupressure or reflexology known pressure point locations on the sole of the foot, can be effective in achieving short-term and medium-term relief from chronic foot pain due to various etiologies, and can indeed be helpful in overall health terms, such as showing demonstrable positive effects on heart rate and blood pressure.

A system comprising: one or more massage pads; a plurality of actuators coupled to the one or more massage pads, with each actuator configurable to have one or more positions and one or more modes of operation; a controller communicably coupled with the plurality of actuators and configured to: position the actuators according to one of industry specified pressure points and industry specified pressure points plus user defined adjustments; and actuate the plurality of actuators based on one or more massage modalities and the one or more modes of operation.

The massage pad(s) may have a gel-containing or firm foam padded strap.

In an embodiment, the system further comprises an interactive graphical display unit communicably coupled to the controller. The interactive graphical display unit is configured to display pressure points, wherein the displayed pressure points are scaled representations of one of industry specified pressure points and industry specified pressure points plus user defined adjustment; and send one or more user defined messages, commands, or both to the controller.

In another embodiment, the controller is further configured to: receive the one or more messages, commands, or both; and perform one or more processing actions according to the one or more messages, commands, or both.

In some embodiments, the industry specified pressure points are one of acupressure and reflexology pressure point locations on a sole of a foot.

In some embodiments, the actuators are pneumatic pistons.

In still yet another embodiment, each massage modality of the one or more massage modalities comprises a massage routine and at least one element of information selected from a group consisting of: actuator position information, actuator orientation information, actuator velocity information, actuator acceleration information, and massage duration information.

Additional features known in the art may operate either simultaneously with or independently of the pressure-point massage function and/or with one another as selected by the user via a GUI on a hand-held console. These may include one or more of the following. A vibration apparatus may impart several user-chosen intensity levels of vibration to a footpad. A system may add infra-red therapy (heat) to the footpad. A system may enable electro-stimulation of the muscles of the foot and lower limb below the knee.

A self-massaging device according to embodiments of the present invention may be configured for application to other anatomical sites, such as the lower back, upper and mid-back, the neck, the calves and thighs, etc. Modifications of the control pad and the size/shape/position of the tP array can easily be understood and created to engender variations of the device to allow a user to self-massage any or all these areas in a similar manner as described herein for the foot.

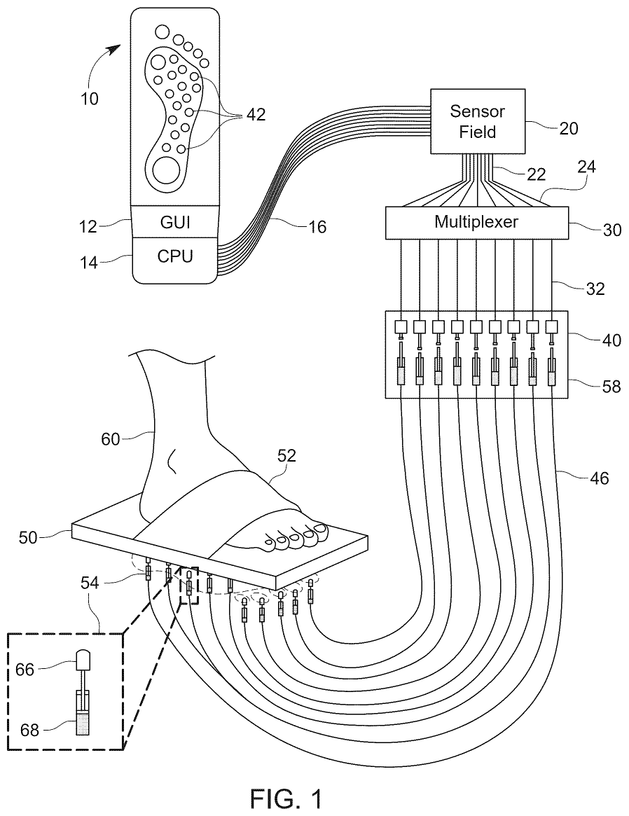

Referring to FIGS. 1 through 11, examples of various embodiments of a robotic foot self-massager (RFSM) are discussed below.

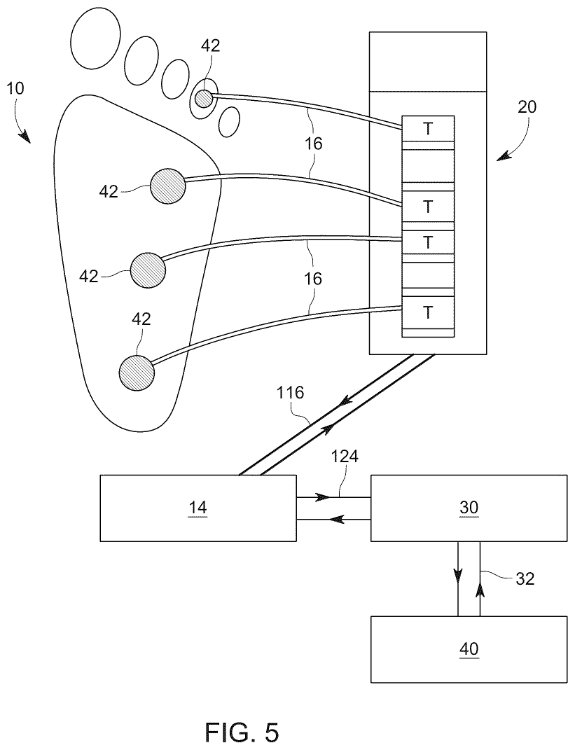

Referring to FIGS. 1, 2A, 2B, 2C, 3A, 3B, 3C-10A, 10B, and 11, a massager according to a first embodiment of the present invention is illustrated in FIG. 1. The massager may comprise a hand-held control pad or console 10, in the shape of or presenting an image of an adult human footprint, upon which are located several compressible pads or buttons 42 are distributed in the configuration representative of commonly utilized foot massage pressure points 56. The buttons 42 are, or activate, pneumatic pistons (not shown), referred to hereinafter as primary pistons (pP). The control console 10 may also have a graphical user interface (GUI) 12 and operatively associated CPU 14 located thereon from which the user may choose to record and name/label a user-customized massage protocol or to choose from a menu of pre-programmed protocols, amongst other features to be discussed below. In some cases, a user selection made via the GUI causes the CPU to actuate the primary pistons pP. Pneumatic tubing 16 (e.g., 1/16″ to 3/16″ inner diameter) leads from each compressible button 42/associated pP to a dedicated pneumatic pressure transducer T in a transducer/sensor field 20; see FIG. 5. The pressure transducer field 20 is electrically connected to a multiplexer 30 via electrical wiring and/or cords 22, 24. The multiplexer is operatively connected to individual linear servo actuators 42 (with motor driver, not shown) arranged in a dedicated actuator field 40. Each servo actuator 42 may then compress or decompress a dedicated secondary hydraulic piston/syringe (sP) 58 which is in turn connected via hydraulic tubing 46 (e.g., 3/16″ inner diameter) to a dedicated tertiary piston (tP) 66 in an array 54 of tertiary pistons 66 housed in a footpad assembly having footpad 50 with a padded strap 52 into which the user inserts one or both feet 60, such that their foot (feet) 60 rests on the pad(s) 50. The tP 66 array 54 may be arranged in or under the footpad 50 a pattern corresponding with and spatially/geometrically correlated to the hand-held control console 10. The dorsum of the user's foot/feet 60 can then be constrained by the padded strap 52 which can be tensioned according to the preference and comfort level of the user. The foot pad may be foot-shaped and may be formed of rubber, silicone, or elasticated fabric. Software, e.g., operated by the CPU, may read and interpret the force and speed of the compression or decompression of the pP when acted upon by the users' fingers and calculates and applies appropriate software command modulation factors to result in proportional movements of the servo-actuators 40 and ultimately the tPs 66 to result in a pressure point 56 compression to the sole of the user's foot 60 that will feel to the user like a human fingertip applying such pressure at the user-determined specific location.

In the case of the human foot 60, significant size differences are well known and result in differential application of point 56 pressure especially between the extremes of sizes, as each massage point 56 of the individual tPs 66, particularly those at the periphery of the array 54, might contact a different part of the sole of the foot 60 than the user may expect given the appearance of the array 54 on the hand-held controller 10. As such, one possible solution to this problem is to employ a mechanism that can adjust the spacing of the massage points 56 according to the specific size of the user's foot 60, thereby accommodating any number of different user's feet 60. Anatomical study and laboratory testing may find that rather than needing a specific setting for each standard foot size, fewer settings for use in several ranges of foot size (e.g., US size W4 to W7, W8 to W11, W12 to W14, i.e., three ranges of female 60 sizes) may be adequately accommodated by three distinct massage point 56 array 54 configurations as opposed to fourteen separate ones. The same logic may be applied to ranges of men's foot sizes, with overlapping sizes of either female or male sizes resulting in even fewer necessary unique array 54 configurations. The user can customize the massage point 56 array 54 configuration from the GUI 12.

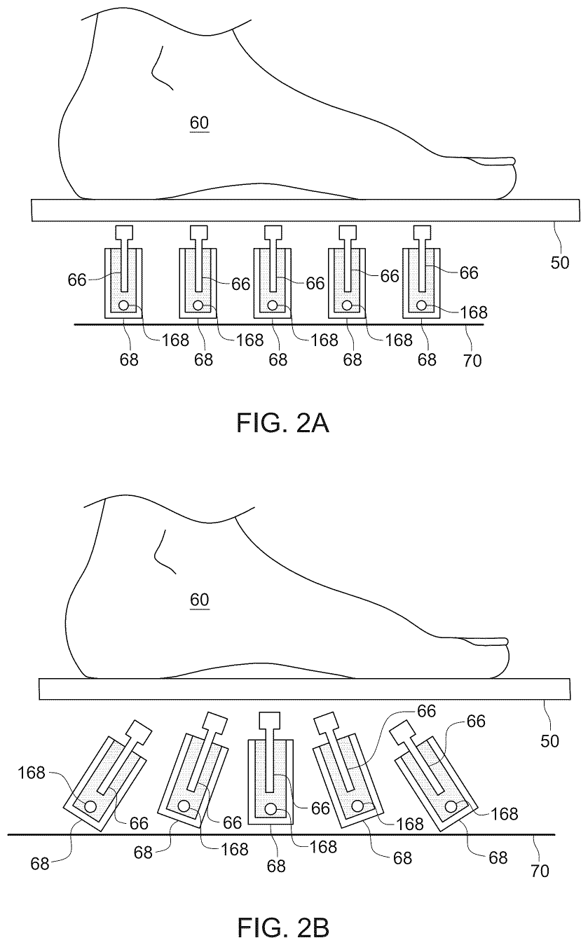

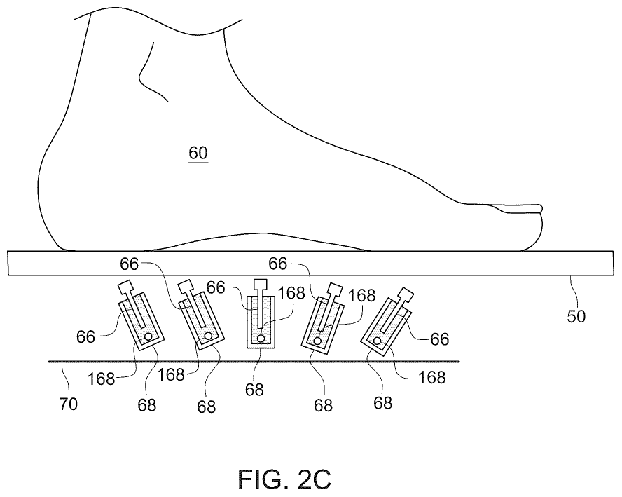

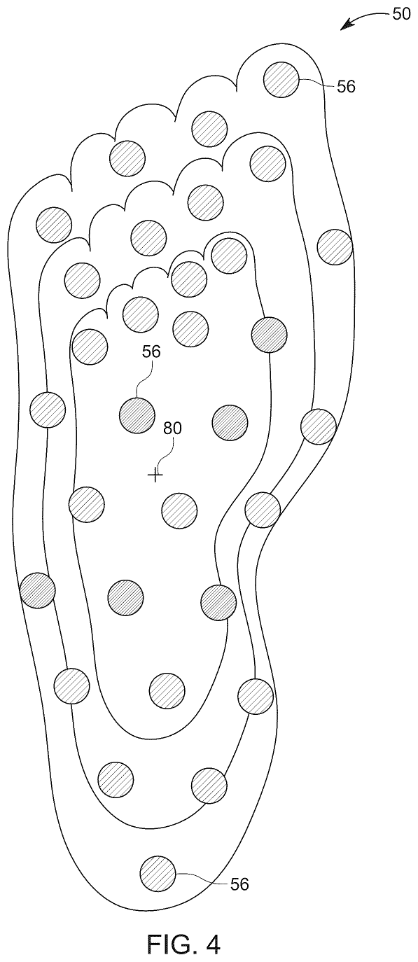

An example mechanism that provides for such customization is a cylindrical housing 68 shown in FIGS. 2A, 2B, and 2C that houses the tPs 66, each of which are attached to a baseplate 70 by a motorized hinge joint 168. By tilting the cylindrical housing 68 east or west, or north or south, relative to a center point 80 (see FIG. 4) on the array 54, the massage points 56 are either farther away from the center point 80 (for larger foot sizes) or closer to the center point 80 (for smaller foot sizes). In doing so, the relative spatial arrangement of the massage points 56 remain the same regardless of the user's foot 60 size, leading to a similar massage experience for the majority of users.

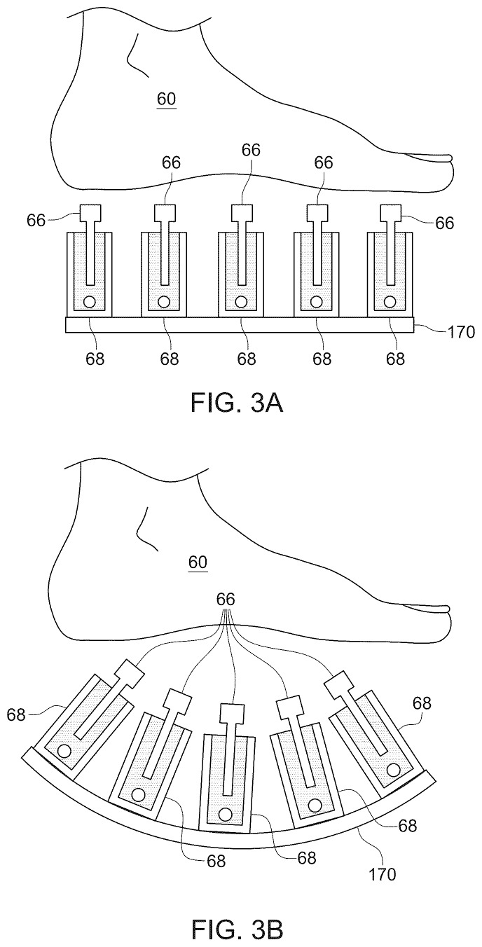

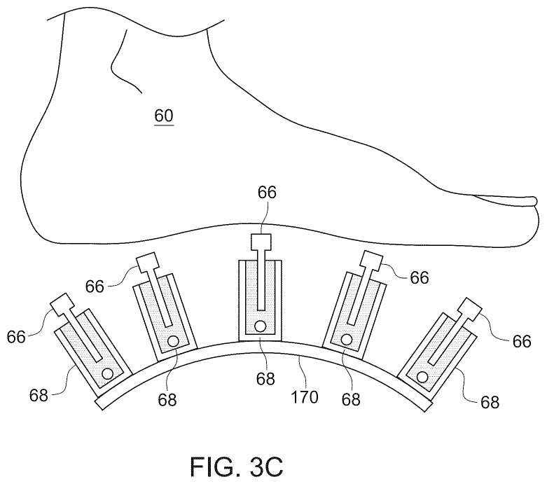

A mechanism according to another embodiment of the present invention is shown in FIGS. 3A, 3B, and 3C, wherein the cylindrical housings 68 are attached (joined, affixed, or mounted) at their bases to a flexible baseplate 170. When flexed convex relative to the user's sole, the baseplate 170 causes the massage points 56 to spread apart, and when flexed concave relative to the user's sole, the baseplate 170 causes the massage points 56 to crowd together. In this way, massage point 56 customization can also be achieved.

FIG. 4 illustrates yet another embodiment wherein the massage point 56 array 54 contains a very large and densely packed number of tPs 66 arranged beneath the footplate 50 to accommodate the largest usual male shoe size (e.g., US size M16). In this solution, more possible massage pressure points 56 are available to the larger foot sizes, however even the smallest foot size is able to utilize the most accessed pressure points 56 on the sole, while the peripheral tPs 66 and their massage points 56 are not utilized as they fall outside of the perimeter of the smaller foot 60 sizes. The GUI 12 can be configured to provide the user with tPs 66 that are within the perimeter of the respective foot size range. The GUI 12 can be configured to not display the tPs 66 outside of the selected foot size perimeter as potential choices for activation.

Other configurations that account for foot size variability are contemplated based on the aforementioned configurations.

It is also evident that regarding other parts of the body (back, neck, thighs, calves, etc.), the anatomical variation present in humans may not present similarly significant challenges to users in terms of achieving equivalent massage experiences, and as such most or all of the size-adjustment approaches described above may not be necessary in self-massage devices designed for areas other than the foot 60. In these embodiments, there may be a “one size fits most” approach to the design of the devices.

Whether one administers or receives a massage, it is well known that variations in point 56 pressures are necessary and desirable. For example, if a particular spot is excessively sensitive to deep, hard, compression, then it may be necessary to avoid such levels of pressure and apply gentler compression. Conversely, some areas may require high-pressure manipulation to achieve relief of symptoms, while gradually increasing and decreasing massage pressures to other areas may be desirable. Therefore, the user may instruct the system to apply different levels of pressure (manifested mechanically by variation in the outward/inward stroke of the servo-actuator 42 with resultant differential stroke lengths of the sPs 58) from the GUI 12. FIGS. 5-8 illustrate various embodiments according to the present invention of registering and imparting variable massage pressure intensity.

In one embodiment of the present invention shown in FIG. 5, the pneumatic buttons 42 of control pad 10 are connected via hollow tubing 16 to pressure transducers T in the sensor array 20. A central processing unit (CPU) 14 connected to the sensor array 20 via electrical wires 116 converts the pressure readings into distance commands via software conversion factors and a multiplexer 30 connected to the CPU 14 by electrical wires 19 manipulates individual components within the actuator field 40 via electrical wires 32. This approach has been constructed and validated in a working prototype.

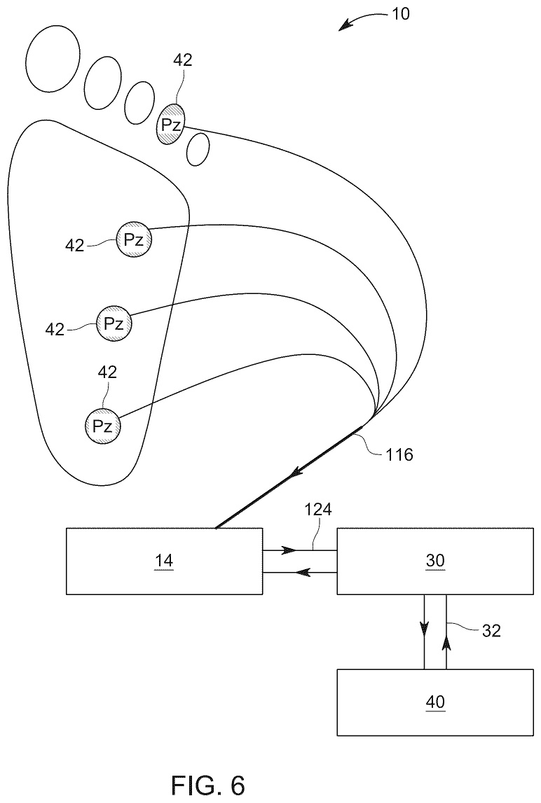

FIG. 6 illustrates another embodiment, in which piezoelectric (Pz) pressure sensors embedded within the hand-held control pad 10 buttons 42 respond to variable levels of applied direct pressure and send the pressure information electronically via electrical wires 116 to the CPU 14 and via electrical wires 124 to the multiplexer 30 to achieve different levels of pressure in selected areas of the actuator field 40 by way of electrical wires 132.

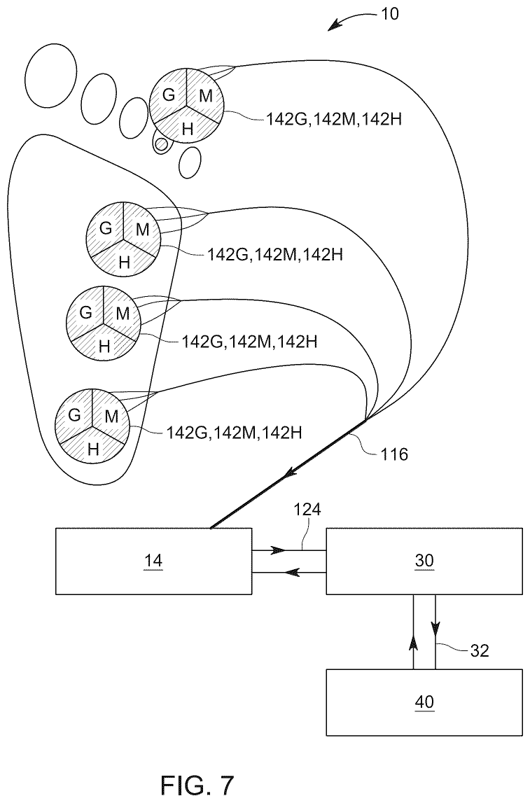

In yet another embodiment illustrated in FIG. 7, a limited variety of massage pressure level selections, such as three increasing pressure levels (e.g., gentle [G], moderate [M], hard [H] selections for massage pressure intensity) may be provided in a pre-programmed choice menu on the control pad 10, with each button 42 being composed of a segmented composite 142G, 142M, 142H representative of the three levels. The user may press a button 142G, 142M, 142H to electronically send a signal via electrical wires 116 to the CPU 14 and multiplexer 30, via electrical wires 124, to produce the selected massage pressure in each region of the actuator field 40 via electrical wires 32.

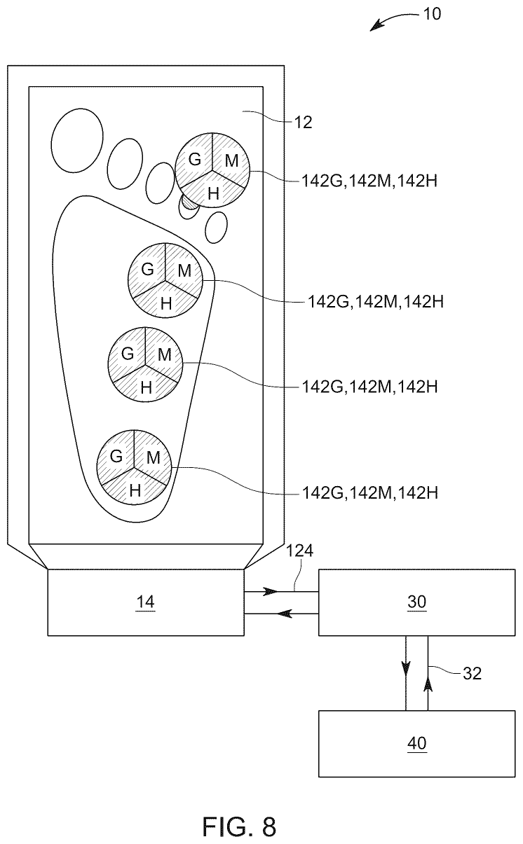

FIG. 8 shows yet another embodiment, in which the graphical control pad 10 presents a GUI 12 having a touch-sensitive screen operated with a CPU 14, giving the user a graphical or animation version of the segmented control buttons 142G, 142M, 142H, which when selected activate selected pressure levels of massage effected via the multiplexer 30 and actuator field 40 by way of electrical wires 124 and 32.

The embodiments illustrated in FIGS. 7 and 8 result in a diminished ability of the system to most accurately emulate the precise degree of pressure that the user may wish to apply to the body part (e.g., sole of foot 60 in the present discussion). However, it may be technically simpler to realize the self-massage device using such a strategy as compared to the embodiments illustrated in FIGS. 5 and 6. Therefore, it may be seen that the process of registration and impartation of variable massage pressure intensity can be accomplished by several mechanisms.

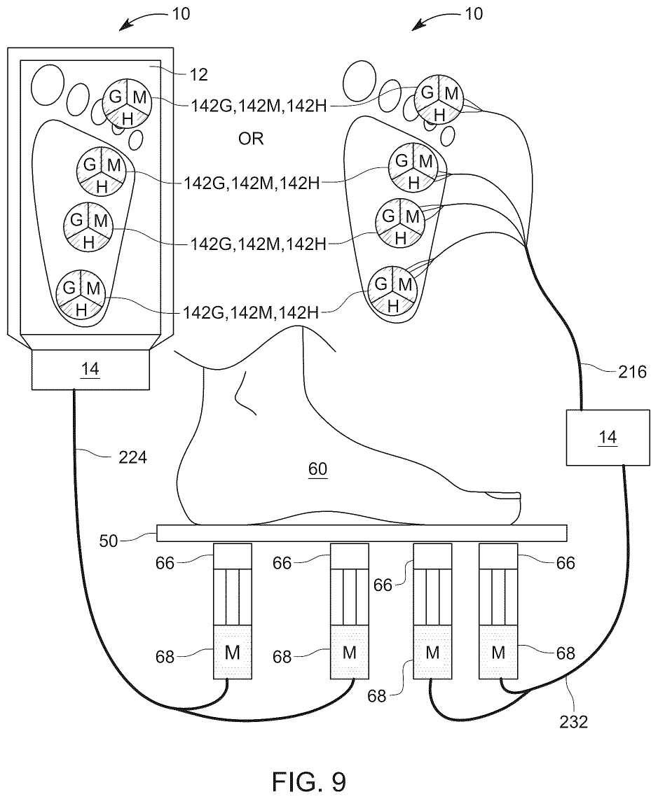

In perhaps the simplest embodiment shown in FIG. 9, gentle-moderate-hard (GMH)-segmented buttons 142G, 142M, 142H on the control pad 10 (whether physical buttons or generated by the GUI 12) are electronically connected via CPU 14 (with electrical wires 224 or 216, 232) directly to actuators 66, 68 placed in direct contact with the massage pad 50. Differential intensities of massage pressure based on the degree of movement of the actuator piston 66 may be imparted by motor M (more or less) depending upon which button 142G, 142M, 142H was pressed by the user.

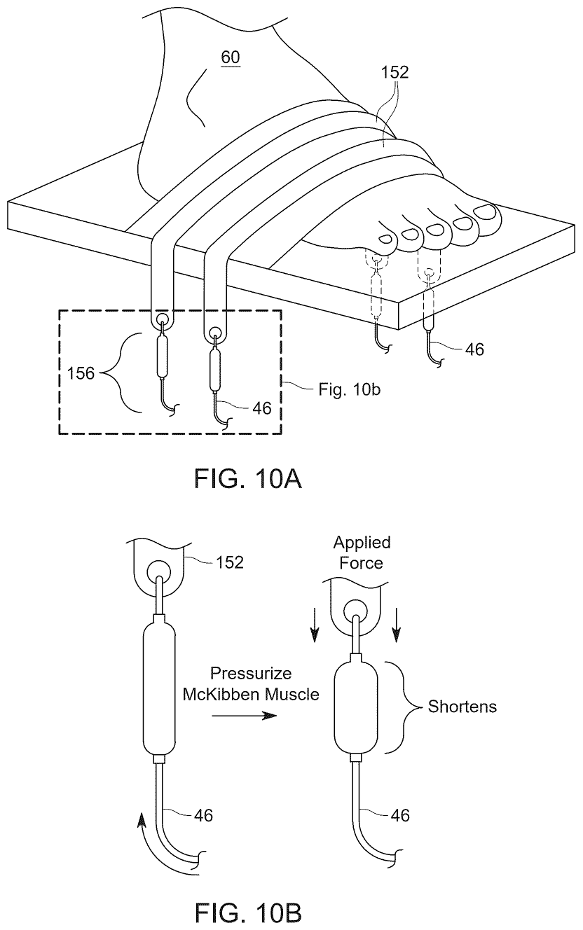

When receiving a manual foot massage, pressure on the sole of the foot 60 is often balanced by equivalent or near equivalent pressure on the dorsum, occurring simultaneously. This often results in a deep pressure transmission to the entire depth of the tissues and is perceived as a pleasant sensation. To accomplish this effect, FIG. 10A illustrates an embodiment having several flexible counterpressure bands 152 can be implanted or positioned within the dorsal retention strap 52 and attached to actuators (either directly or using cables and pulleys) on opposing ends. It is envisioned that hydraulic actuators that shorten on pressurization, such as pneumatic artificial muscles (PAMs) known as Mckibben fluidic “muscles” 156, can be employed for this purpose. The Mckibben muscle actuators 156 are synchronized with the tPs 66 in the corresponding region of the tP array 54 such that activation of sPs 58 causes activation of the appropriate Mckibben muscle 156 pair to result in application of dorsal pressure across the width of the strap 52. FIG. 10A shows hydraulic tubing 46 from the actuator field 40 coupled to Mckibben muscles 22. FIG. 10B illustrates how pressure from the hydraulic tubing 46 shortens the Mckibben muscle 22, thereby applying force on the bands 152. This is only one possible method of achieving dorsal counterpressure. Other methods can be employed and are contemplated herein.

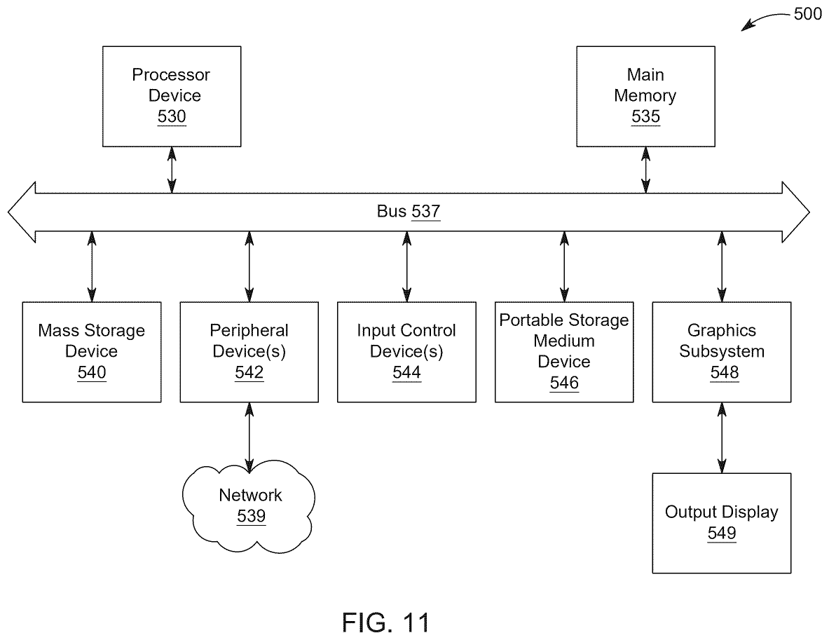

FIG. 11 is a block diagram of a general and/or special purpose computer 500, which may be a general and/or special purpose computing device, in accordance with some of the example embodiments of the invention. The computer 500 may be, for example, a user device, a user computer, a client computer and/or a server computer, among other things.

The computer 500 may include without limitation a processor device 530, a main memory 535, and an interconnect bus 537. The processor device 530 may include without limitation a single microprocessor or may include a plurality of microprocessors for configuring the computer 500 as a multi-processor system. The processor device 530 may include or may be in addition to the CPU 14. The main memory 535 stores, among other things, instructions and/or data for execution by the processor device 530. The main memory 535 may include banks of dynamic random-access memory (DRAM), as well as cache memory.

The computer 500 may further include a mass storage device 540, peripheral device(s) 542, non-transitory storage medium device(s) 546, input control device(s) 544, a graphics subsystem 548, and/or a display 549. The peripheral devices 542 may include the GUI 12 or may be in addition to the GUI 12. For explanatory purposes, all components in the computer 500 are shown in FIG. 11 as being coupled through the bus 537. However, the computer 500 is not so limited. Devices of the computer 500 may be coupled through one or more data transport means. For example, the processor device 530 and/or the main memory 535 may be coupled through a local microprocessor bus. The mass storage device 540, peripheral device(s) 542, portable storage medium device(s) 546, and/or graphics subsystem 548 may be coupled via one or more input/output (I/O) buses. The mass storage device 540 may be a nonvolatile storage device for storing data and/or instructions for use by the processor device 530. The mass storage device 540 may be implemented, for example, with a magnetic disk drive or an optical disk drive. In a software embodiment, the mass storage device 540 is configured for loading contents of the mass storage device 540 into the main memory 535.

The portable storage medium device 546 operates in conjunction with a nonvolatile portable storage medium, such as, for example, a compact disc read only memory (CD-ROM), to input and output data and code to and from the computer 500. In some embodiments, the software for storing information may be stored on a portable storage medium and may be inputted into the computer 500 via the portable storage medium device 546. The peripheral device(s) 542 may include any type of computer support device, such as, for example, an input/output (I/O) interface configured to add additional functionality to the computer 500. For example, the peripheral device(s) 542 may include a network interface card for interfacing the computer 500 with a network 439.

The input control device(s) 544 provide a portion of the user interface for a user of the computer 500. The input control device(s) 544 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 500 may include the graphics subsystem 548 and the output display 549. The output display 549 may include a cathode ray tube (CRT) display and/or a liquid crystal display (LCD). The graphics subsystem 548 receives textual and graphical information and processes the information for output to the output display 549.

Each component of the computer 500 may represent a broad category of a computer component of a general and/or special purpose computer. Components of the computer 500 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-ray Disc, a Digital Video Disc (DVD), a CD or CD-ROM, a micro-drive, a magneto-optical disk, a Read Only Memory (ROM), a RAM, an Erasable Programmable Read Only Memory (EPROM), an Electrically Erasable Programmable Read Only Memory (EEPROM), a DRAM, a Video Random Access Memory (VRAM), a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further include software for performing example aspects of the invention, as described above.

Included in the programming and/or software of the general and/or special purpose computer or microprocessor are software modules for implementing the procedures described above.

While various example embodiments of the present invention have been described above, they have been presented by way of example, and not limitation. It will be apparent to persons skilled in the relevant art(s) that various changes in form and detail can be made therein. Thus, the present invention should not be limited by any of the above-described example embodiments but should be defined only in accordance with the following claims and their equivalents.

In addition, the accompanying figures are presented for example purposes only. The architecture of the example embodiments presented herein is sufficiently flexible and configurable, such that it may be utilized and navigated in ways other than that shown in the accompanying figures. Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A massage system comprising:
one or more massage pads;
a plurality of actuators coupled to the one or more massage pads, with each actuator configurable to have one or more positions and one or more modes of operation; and
a controller communicably coupled with the plurality of actuators, configured to position the actuators to contact selected anatomical pressure points; and configured to actuate the plurality of actuators in accordance with one or more massage modalities and the one or more modes of operation.

2. The system of claim 1, further comprising an interactive graphical display unit communicably coupled to the controller.

3. The system of claim 2, wherein the interactive graphical display unit is configured to:
display pressure points, wherein the displayed pressure points are scaled representations of the anatomical pressure points; and
send one or more user defined messages, commands, or both to the controller.

4. The system of claim 3, wherein the controller is further configured to:
receive the one or more messages, commands, or both; and
perform one or more processing actions according to the one or more messages, commands, or both.

5. The system of claim 4, wherein the anatomical pressure points are selected from acupressure and reflexology pressure point locations on a sole of a foot.

6. The system of claim 1, wherein the actuators are pneumatic pistons.

7. The system of claim 1, wherein each of the one or more massage modalities comprises a massage routine and at least one element of information selected from the group consisting of: actuator position information, actuator orientation information, actuator velocity information, actuator acceleration information, and massage duration information.
